(19) United States
(12) Patent Application Publication
(10) Pub. No.: US 2013/0187955 A1
(43) Pub. Date: Jul. 25, 2013

(54) INTRA-OPERATIVE IMAGE PRESENTATION ADAPTED TO VIEWING DIRECTION

(71) Applicants: Uli Mezger, Heimstetten (DE); Juergen Gassner, Unterfoehring (DE)

(72) Inventors: Uli Mezger, Heimstetten (DE); Juergen Gassner, Unterfoehring (DE)

(73) Assignee: BrainLAB AG, Feldkirchen (DE)

(21) Appl. No.: 13/806,221

(22) PCT Filed: Jul. 6, 2010
(86) PCT No.: PCT/EP2010/059614

§ 371 Date: Mar. 11, 2013

(51) Int. Cl. G09G 5/34; G06F 3/01

(52) U.S. Cl. CPC G09G 5/34; G06F 3/011
USPC 345/649; 345/156

(57) ABSTRACT

The invention relates to an intra-operative image presentation method, in which an image representation (30) of a branched body structure which has been graphically segmented from a medical image data set is presented on a display, in particular a monitor (17), wherein the viewing situation of a person looking at the display and any changes in said viewing situation are determined, and the image representation is modified accordingly by adapting the image representation (30) to the changes in the viewing situation. The invention also relates to an intra-operative image presentation system, comprising a display, in particular a monitor (17), on which an image representation (30) of a branched body structure which has been graphically segmented from a medical image data set is presented, wherein a tracking system (6) determines the viewing situation of a person looking at the display (17) and any changes in the viewing situation, and a graphic processor modifies the image representation (30) by adapting it to the determined changes in the viewing situation.

The present invention relates to intra-operative image presentation within the medical field which is adapted to the viewing direction.

Medical image data such as data acquired from MR scans can comprise information about branched body structures, such as for example vessel structures in a patient's brain. Using a particular image processing method known as “segmentation”, such branched structures can be visually separated from the surrounding tissue and shown in isolation on an image display, such as for example a monitor which is set up in an operating theatre. Such monitors are often used within medical navigation systems or image-guided surgery systems, one example of which is disclosed in DE 196 39 615 A1. Where medical navigation systems or tracking systems associated with them are discussed in the present specification, it may be understood that they are designed in a way corresponding to those disclosed in the aforementioned document

When viewing such a branched body structure—such as for example a three-dimensional vessel “tree”—on a two-dimensional monitor screen, it is difficult for the viewer to obtain proper depth information, i.e. information about vessel structures hidden behind other structural parts in the viewing direction. In order to solve this problem, radiologists have used a method which creates “depth from motion” when viewing such branched body structures on a monitor outside of the operating theatre, for example when preparing for a treatment. In this method, an input device such as a computer mouse is used to move the representation of the vessel tree slightly in various directions on the monitor screen, for example by rotating said representation.

Looking at such a moved (or animated) rotated representation enables a viewer to obtain more depth information. However, using an input device such as a mouse is problematic in intra-operative situations, for a variety of reasons. On the one hand, for example, a surgeon simply does not have the time or freedom to interrupt the operation in order to operate a mouse so as to rotate the image of the vessel tree on the monitor. On the other hand, such input devices are difficult to provide and maintain in a sterilised form in an operating theatre.

Using special three-dimensional hardware, including 3D monitors, is very expensive and hardly practical in an operating room setup due to sterility and viewing-direction issues.

It is the object of the present invention to provide intra-operative image presentation which does not suffer from the aforementioned drawbacks. The invention in particular aims to provide an easy-to-handle image presentation system and method for intra-operative purposes in connection with branched body structures.

In accordance with one aspect of the present invention, the aforementioned object is achieved by an intra-operative image presentation method in accordance with claim 1. In another aspect, claim 12 defines an intra-operative image presentation system in accordance with the present invention. The sub-claims define advantageous embodiments of the present invention,

In an intra-operative image presentation method according to the present invention, an image representation of a branched body structure which has been graphically segmented from a medical image data set is presented on a display, in particular a monitor. The viewing situation of a person looking at the display and any changes in said viewing situation are determined, and the image representation is modified accordingly by adapting it to the changes in the viewing situation. In other words, the method of the present invention determines how the viewer is looking at the representation or display and manipulates the representation on the display on the basis of this information, such that the representation is presented in different ways, depending on how it is being looked at.

One advantage of the present invention is that the viewing situation itself is evaluated in order to adapt the image representation, such that it is no longer necessary to use an input device for this purpose. This eliminates sterility problems and problems with interrupting the surgeon's work. However, the invention still ensures that the surgeon has all the necessary information from adapted views of the image representation, in particular the above-mentioned depth-from-motion information.

The viewing situation can include the viewing direction, in which case it is possible to modify the image representation by rotating it in accordance with a change in the viewing angle. In addition to this, or as a stand-alone feature, the viewing situation can include the viewing distance, in which case the image representation can be modified by being zoomed-in or zoomed-out in accordance with a change in the viewing distance. The image representation can be presented two-dimensionally, i.e. as a two-dimensional representation of a three-dimensional body structure, wherein a three-dimensional impression is in particular created using the aforementioned depth-from-motion effect, such that the image representation shows different or length-adapted portions of the body structure. Other ways of creating a three-dimensional impression can also be used with the present invention, i.e. for example using or adapting shading effects for portions of the body structure (depending on the viewing situation).

In order to create or complement the three-dimensional impression, one embodiment of the present invention shows the image representation of the body structure in front of or together with a spatial background which is in turn adapted to changes in the viewing situation, in the same way as the image representation of the body structure is adapted. The background can be a perspective background and/or a background which gives the impression of a three-dimensional space. A (central) perspective background, such as a tunnel or quadrangular space, can be used together with a grid structure which can then be adapted in accordance with the viewing situation, in particular the viewing direction.

The body structure which is to be represented can be a vessel structure or a vessel tree structure or for example a neural structure. It should be noted that any body structure which is branched or formed in such a way that parts of it may be hidden behind other parts in certain viewing situations would be suitable for being presented using a method in accordance with the present invention.

In technical terms, the viewing situation—in particular, the viewing direction or distance—can be determined by detecting the relative position of the head of the person looking at the display (the viewer) and the display itself, such as in particular a medical display. It can be detected by means of a spatial tracking system, in particular a tracking system which supports medical navigation, such as in particular a camera tracking system. To this end, it can be advantageous to track the position of the person's head by means of the tracking system, in particular via a tracking reference, while the position of the display is either predetermined or is known or calibrated as an absolute spatial position or is likewise tracked by means of the tracking system, in particular via a tracking reference.

The position of the person's head can be tracked by various means, for example:
video-tracking the head itself, its contours or certain elements such as the eyes;
video-tracking markings on the head or on clothing or devices worn on the head;
tracking the head itself, its contours or certain elements such as the eyes, or markings on the head or on clothing or devices worn on the head, by means of the tracking system.

In accordance with one embodiment of the present invention, the image data set and the information about the changes in the viewing situation, in particular the tracking data, are processed in a graphic processor which controls the image representation on the display and is in particular incorporated in a medical navigation system.

The intra-operative image presentation system according to the present invention comprises a display, in particular a monitor, on which an image representation of a branched body structure which has been graphically segmented from a medical image data set is presented. The system is characterised by a tracking system which determines the viewing situation of a person looking at the display and any changes in the viewing situation, and by a graphic processor which modifies the image representation by adapting it to the determined changes in the viewing situation. The graphic processor can in particular be incorporated in a medical navigation system which is linked to the tracking system used.

The tracking system can be any one of the following tracking systems:
a video-tracking system for tracking the head itself, its contours or certain elements such as the eyes;
a video-tracking system for tracking markings on the head or on clothing or devices worn on the head;
a tracking system which supports medical navigation, in particular a camera tracking system, for tracking the head itself, its contours or certain elements such as the eyes, or markings on the head or on clothing or devices worn on the head, by means of the tracking system.

The present invention also relates to a program which, when it is running on a computer or is loaded onto a computer, causes the computer to perform a method as described here in various embodiments. The invention also relates to a computer program storage medium comprising such a computer program.

The invention will now be described in more detail by referring to particular embodiments and to the attached drawings. It should be noted that each of the features of the present invention as referred to here can be implemented separately or in any expedient combination. In the drawings:

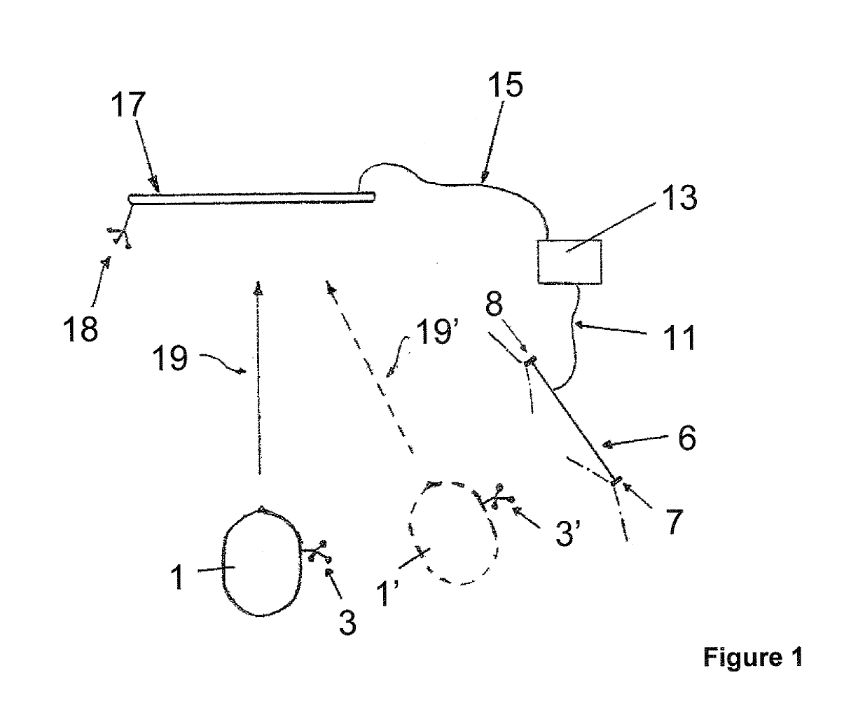

FIG. 1 schematically shows a set-up for an intra-operative image presentation system in accordance with an embodiment of the present invention;

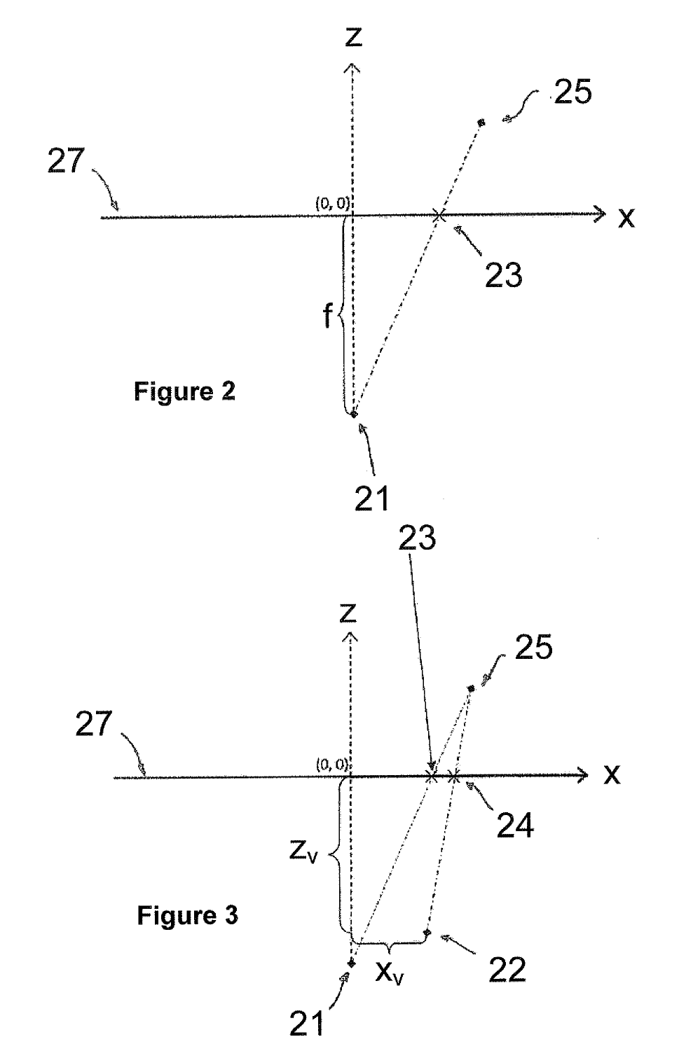

FIGS. 2 and 3 are graphical representations illustrating the monitor projection of a point in three-dimensional space;

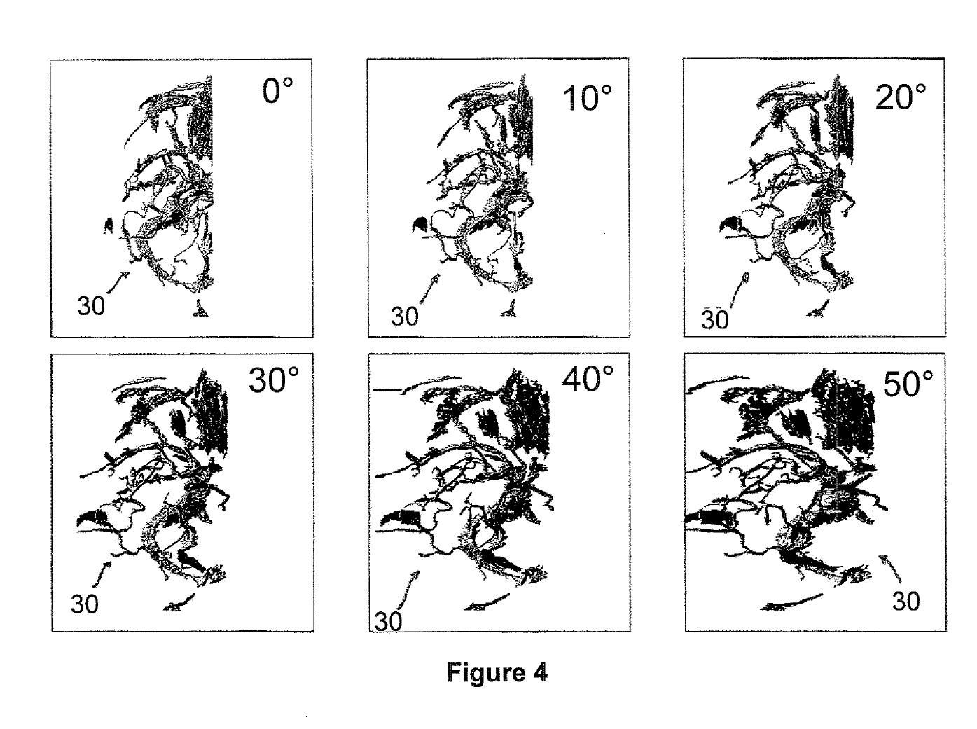

FIG. 4 shows six depictions of a vessel tree, as viewed from six different viewing directions; and

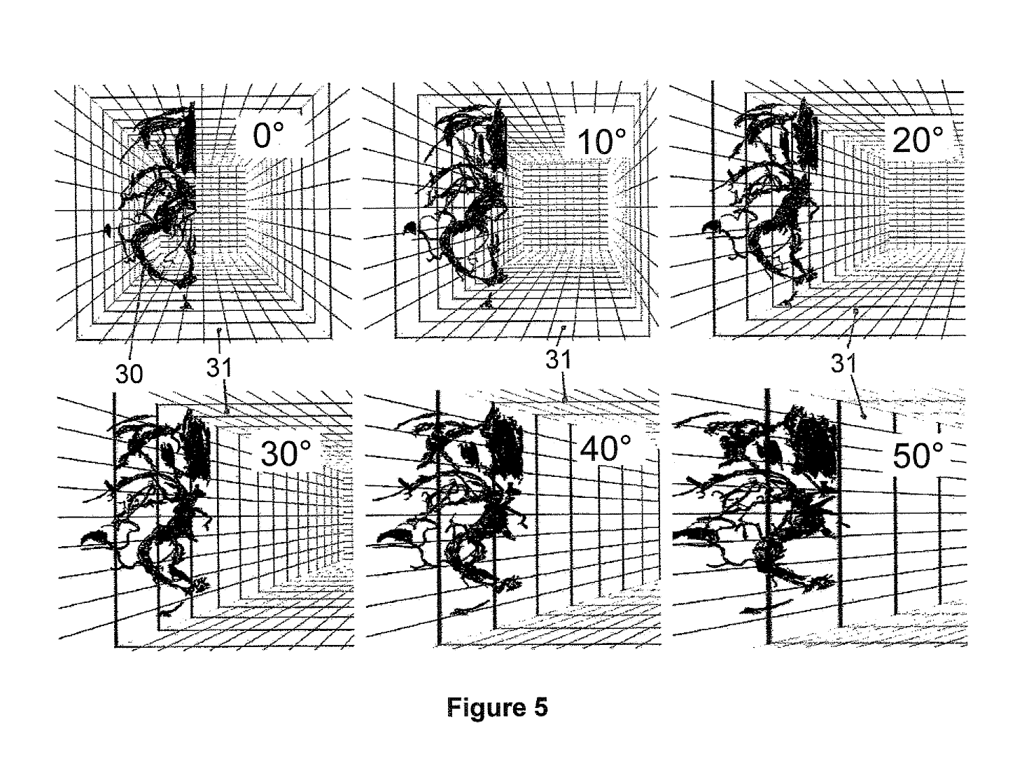

FIG. 5 shows the depictions from FIG. 4, complemented by an animated, adapted background grid.

A general arrangement for employing the present invention is schematically shown in FIG. 1. The head of a user, for example a surgeon using the image presentation system of the present invention, has been given the reference numeral 1 in FIG. 1 and, as with all the elements in FIG. 1, is shown in a schematic top view. A reference device 3, which is a star-like device comprising three reflective markers, is attached to the user's head 1. The reference device 3 is tracked by a tracking system which is schematically shown in FIG. 1 and has been given the reference numeral 6. The tracking system 6 includes two cameras 7 and 8, by means of which a three-dimensional spatial position of the reference device 3 can be determined. This determined position of the reference device 3—and therefore of the head 1—is transferred via a line 11 to a medical navigation system 13 which, as with all the components shown in FIG. 1, is arranged in an operating theatre. Previously acquired image data are positionally registered and graphically processed in the medical navigation system 13 and then sent via a line 15 to a monitor 17 on which said image data, for example image data of a vessel tree, are displayed. Since FIG. 1 shows a top view, the monitor 17 is of course only visible by its longitudinal upper edge.

The tracking system 6 can also positionally locate and track a reference device 18 which is fixed to the monitor 17. The tracking information about the position of the monitor 17 and about any positional shift, i.e. the relative position between the head 1 (and/or the reference device 3, respectively) and the monitor 17 (and/or the reference device 18, respectively) is inputted via the line 11 into the medical navigation system, where it is processed. In accordance with the present invention, the image representation shown on the monitor 17 is adapted to the viewing situation—in this case, the relative position of the head 1 and the monitor 17. The viewing situation can however also be represented by a viewing direction 19. If, for example, the user's head 1 shifts slightly to the right and thus changes its viewing angle, this results in a new viewing situation, shown by way of example in FIG. 1 by the dashed lines of the head 1′, the reference device 3′ and the new viewing direction 19′. The image representation on the monitor 17 will then be adapted to the change in the viewing situation, as described in the following.

FIG. 2 schematically shows how a three-dimensional point 25 is conventionally projected into the two-dimensional plane 27 of a monitor, i.e. without adapting to the user's position. The user's position is shown at 21 and exhibits a “focal distance” f, i.e. a perpendicular distance from the monitor plane 27. In this example, the point 25 in three-dimensional space has the co-ordinates x₃, y₃ and z₃, and conventional projection will result in a projected point where the line between the points 21 and 25 intersects the monitor plane 27.

The x and y co-ordinates x₂ any y₂ of the projected point on the monitor plane 27 can be calculated as follows:

$${x}_{2} = \frac{{x}_{3}}{1 + \frac{{z}_{3}}{f}} ;$$

$${y}_{2} = \frac{{y}_{3}}{1 + \frac{{z}_{3}}{f}} .$$

FIG. 3 shows how such a representation would be adapted to a change in the user's viewing situation, i.e. in the given example, the viewer's position. In FIG. 3, the user has moved to the right by the distance xᵥ and slightly forwards, such that the user's new position 22 is situated at a distance zᵥ from the monitor plane 27. While the reference numerals 23 and 21 still show the former projected point and the former point of view from FIG. 2, respectively, the new point of view in this example would then be situated at 22, and the new projected point—exhibiting new co-ordinates x₂ and y₂—would be situated at 24, i.e. such that the standard projection point 23 has been moved to the adapted projection point 24, wherein the new x and y coordinates x₂ and y₂ can then be calculated as follows:

$${x}_{2} = \frac{{x}_{3} - {x}_{v}}{1 + \frac{{z}_{3}}{{z}_{v}}} + {x}_{v} ;$$

$${y}_{2} = \frac{{y}_{3}}{1 + \frac{{z}_{3}}{f}}$$

i.e. the point is first shifted by the distance xᵥ, then projected in the same way as a standard projection (but using the actual distance from the monitor zᵥ instead of the fixed focal distance value f) and then shifted back again by the distance xᵥ.

By adapting the image representation in this way, i.e. by changing it in accordance with the present invention, the image representation itself is changed in accordance with the viewing angle. If, as in FIG. 1, the viewing angle is shifted and turned to the right (from 19 to 19′), the image representation of a vessel tree would change accordingly, wherein FIG. 4 shows for example a series of different image representations in accordance with a change in the viewing angle from 0° to a final viewing angle of 50° in increments of 10°.

In order for the change in viewing angle to be intuitively visible to a person using the system, the image representation 30 can be accompanied by a background 31, as shown in the six images in FIG. 5. The vessel tree 30 is shown for the same set of viewing angles as in FIG. 4, but a (sort of) tunnel grid 31 is additionally presented together with the image of the vessel tree and provides a spatial background which is correspondingly “turned” or “rotated” in accordance with the viewing direction and/or changes in the viewing direction. By following the rotations from 0° to 50°, it is easy to see that the person's viewing angle has been turned because the person's head has moved to the right and turned slightly to the left, as shown in FIG. 1.

Thus, the present invention utilises the position of the user (or the user's head) relative to an ordinary display monitor in order to display a three-dimensional (surface-rendered or volume-rendered) image of a vessel tree on the monitor. By tracking the position of the user relative to the monitor, the three-dimensional scene can be adapted in such a way as to create the impression that the user is looking at a “real” three-dimensional scene through the display. By constantly tracking the head's position and correspondingly adapting the 3D scene displayed, it is possible to achieve increased depth perception (depth from motion), because the image representation of the vessel tree is being constantly updated to reflect the new position of the observer. The system in accordance with the invention thus provides a very easy-to-handle “interface” for adapting the image representation, since only small (head) movements by the user are required in order to provide an intuitive feedback.

1. An intra-operative image presentation method, in which an image representation of a branched body structure which has been graphically segmented from a medical image data set is presented on a display, in particular a monitor, characterised in that the viewing situation of a person looking at the display and any changes in said viewing situation are determined, and the image representation is modified accordingly by adapting the image representation to the changes in the viewing situation.

2. The method according to claim 1, wherein the viewing situation includes the viewing direction, and the image representation is modified by rotating it in accordance with a change in the viewing angle.

3. The method according to claim 1, wherein the viewing situation includes the viewing distance, and the image representation is modified by being zoomed-in or zoomed-out in accordance with a change in the viewing distance.

4. The method according to claim 1, wherein the image representation is a two-dimensional representation of a three-dimensional body structure, wherein a three-dimensional impression is in particular created using a depth-from-motion effect, such that the image representation shows different or length-adapted portions of the body structure, or using shading effects for portions of the body structure.

5. The method according to claim 1, wherein the image representation is a two-dimensional representation of a three-dimensional body structure, wherein a three-dimensional impression is in particular complemented by showing the image representation in front of or together with a spatial background which is in turn adapted to changes in the viewing situation, in the same way as the image representation of the body structure is adapted.

6. The method according to claim 1, wherein the body structure comprises a vessel structure or a vessel tree structure.

7. The method according to claim 1, wherein the body structure comprises a neural structure.

8. The method according to claim 1, wherein the viewing situation—in particular, the viewing direction or distance—is determined by detecting the relative position of the person's head and the display, in particular by means of a spatial tracking system, in particular a tracking system which supports medical navigation, such as in particular a camera tracking system.

9. The method according to claim 8, wherein the position of the person's head is tracked by means of the tracking system, in particular via a tracking reference, while the position of the display is either:
pre-determined; or
known or calibrated as an absolute spatial position; or
likewise tracked by means of the tracking system, in particular via a tracking reference.

10. The method according to claim 8, wherein the position of the person's head is tracked by means of:
video-tracking the head itself, its contours or certain elements such as the eyes; and/or
video-tracking markings on the head or on clothing or devices worn on the head; and/or
tracking the head itself, its contours or certain elements such as the eyes, or markings on the head or on clothing or devices worn on the head, by means of the tracking system.

11. The method according to claim 1, wherein the image data set and the information about the changes in the viewing situation, in particular the tracking data, are processed in a graphic processor which controls the image representation on the display and is in particular incorporated in a medical navigation system.

12. An intra-operative image presentation system, comprising a display, in particular a monitor, on which an image representation of a branched body structure which has been graphically segmented from a medical image data set is presented, characterised by a tracking system which determines the viewing situation of a person looking at the display and any changes in the viewing situation, and by a graphic processor which modifies the image representation by adapting it to the determined changes in the viewing situation, wherein the graphic processor is in particular incorporated in a medical navigation system which is linked to the tracking system used.

13. The system according to claim 12, characterised by:
a video-tracking system for tracking the head itself, its contours or certain elements such as the eyes; and/or
a video-tracking system for tracking markings on the head or on clothing or devices worn on the head; and/or
a tracking system which supports medical navigation, in particular a camera tracking system, for tracking the head itself, its contours or certain elements such as the eyes, or markings on the head or on clothing or devices worn on the head, by means of the tracking system.

14. A program which, when it is running on a computer or is loaded onto a computer, causes the computer to perform the method in accordance with claim 1.

15. A computer program storage medium comprising the computer program according to claim 14.
